(19) United States
(12) Patent Application Publication
(10) Pub. No.: US 2007/0005453 A1
(43) Pub. Date: Jan. 4, 2007

(54) Method of client development and retention for restauraunts

(76) Inventor: Thomas Banks, Laguna Niguel, CA (US)

Correspondence Address: STETINA BRUNDA GARRED & BRUCKER, 75 ENTERPRISE, SUITE 250, ALISO VIEJO, CA, 92656, US

(21) Appl. No.: 11/450,792

(22) Filed: Jun. 9, 2006

Related U.S. Application Data
(60) Provisional application No. 60/690,295, filed on Jun. 14, 2005.

(51) Int. Cl. G06Q 30/00

(52) U.S. Cl. 705/27

(57) ABSTRACT

A method of developing and retaining clients is provided. The method may comprise the step of entering into an agreement between a promoter and a restaurant. The restaurant may agree to provide preferred, priority, and/or guaranteed seating to certain patrons redeeming tickets sold by the promoter. The method may also comprise the step of selling dining packages to patrons wherein the dining packages may comprise a plurality of tickets redeemable at various participating restaurants. The method may also comprise the steps of collecting patron data from participating restaurants and updating the patron record and the restaurant data as the tickets are being redeemed. The method may also comprise the step of sending a summary of the updated records of the patron and the restaurant to the patron and the restaurant, respectively. The method may also comprise the step of sending a percentage of the revenues generated by the sales of the dining packages to the participating restaurants on a periodic basis.

### CROSS-REFERENCE TO RELATED APPLICATIONS

This application claims the benefits of U.S. Provisional Application Ser. No. 60/690,295, filed Jun. 14, 2005, the contents of which are incorporated herein by reference.

### STATEMENT RE: FEDERALLY SPONSORED RESEARCH/DEVELOPMENT

Not Applicable

### BACKGROUND

The present invention is related to a method of developing and retaining clients in the field of restaurants.

With little exception, most would agree that restaurant dining is a way of life, especially for businesses. Salespersons, owners, and the like typically discuss business over lunch or dinner. According to the Restaurant Association of America, approximately seven hundred thousand (700,000) restaurant establishments meet the dining needs of both personal and business dining resulting in a three hundred seventy billion dollar per year industry. Fifty two percent of the restaurant establishments are full service facilities with waiters and/or waiters taking orders from seated patrons. Also, fifty five percent of the restaurant establishments are located in ten states, specifically, California, New York, Texas, Florida, Pennsylvania, Illinois, Ohio, New Jersey, Michigan, and Georgia.

To maintain profits, restaurants must develop and retain clients; however, client development costs may be substantial. For example, restaurants may offer clients coupons or other incentives such as two for one deals which reduce the restaurant's margins. Additionally, these types of incentives broadcast the wrong message to their target client base. In particular, these types of incentives broadcast the message that the offering restaurant is not popular and must offer these types of incentives to attract business. Additionally, these types of incentives mostly attract non-paying clientele and are only a short term solution for developing and retaining clients.

Restaurants need a consistent clientele base. To this end, they are constantly seeking methods of developing and retaining clients to increase their clientele base. As a restaurant becomes more effective at developing and retaining clients, the restaurant produces an appearance of popularity thereby making the restaurant more desireable to other clientele. Increased business produces an upward spiral of additional business. Accordingly, any effective method of developing and retaining clients may draw additional clients above those clients drawn to the restaurant through the implemented method. To finance the growth and operations of the restaurant, restaurants also need growth capital and operating capital.

Accordingly, there is a need in the art for an improved method of developing and retaining restaurant clients. Also, there is a need in the art for producing growth capital and operating capital to sustain the restaurant as clients are developed and retained.

### BRIEF SUMMARY

The present invention addresses the needs identified in the background as well as other needs identified herein and known in the restaurant business. The method of the present invention relates to three general areas. The first component provides a monetary incentive and special seating incentive for patrons to dine at participating restaurants. The second component provides growth and operating capital to businesses that participate or join a promoter's group of participating restaurants. The third component provides print and web based advertisements for participating restaurants. These three components assist restaurants in developing and retaining clients in a multi-faceted manner.

A first step in the method of the present invention may include the step of entering into an agreement with a restaurant to join the promoter's group of participating restaurants. The entering into the agreement step may include the steps of executing a promoter's agreement, executing a priority, preferred, or guaranteed seating agreement, promising to enter the restaurant's menu with prices into a website and maintain the menu data, promising to give patrons redeeming tickets preferred, priority or guaranteed seating. Optionally, the entering into the agreement step may further include the step of promising to assign a five (5) percent ownership in the restaurant after one year. The restaurants may also promise to lease a verification computer from the promoter or a third party.

The verification computer may collect data on patrons redeeming tickets. By way of example and not limitation, the data may include the time patrons arrive and depart participating restaurants. As will be discussed below, such data may be transmitted to the promoter, and the promoter may summarize such data and transmit the summary and/or details to (1) the patron (e.g., business, salesperson, individual, etc.) and/or (2) the participating restaurants.

A second step in the method of the present invention may include the step of offering and selling dining packages to patrons. As used herein, “patron” may refer to (1) an individual who dines at a participating restaurant for pleasure or (2) a business that purchases dining packages and distributes the dining packages to its salesforce for company business dinners/lunches with customers. The dining package may comprise a group of tickets based on a patron's dining profile. In particular, the dining profile may reflect the restaurant grade (e.g., cost per entrée), the number of visits (e.g., 5, 10, 15, 20, 30, etc.) during a specified time period (e.g., month, year, etc.), and the number of diners per visit (e.g., 2, 4, etc.). For example, the patron may frequent restaurants in the under $20 per entrée category. The patron may also visit these types of restaurants ten times per month. Additionally, the patron's party may typically comprise four diners. Accordingly, the organizer may sell and the patron may purchase a dining package having twenty tickets. Each ticket may be redeemed at a participating restaurant within the under $20 restaurant grade for up to four diners within a predefined time period (e.g., month, year, etc.). By way of example and not limitation, each of the four dinners may include a soup or salad (excluding entrée salads), main entrée, beverage (excluding alcohol and specialty beverages such as cappuccinos), and tip.

The promoter may enter into agreements with a plurality of restaurants #1, #2, #3, and #n. Simultaneously, the promoter may also sell dining packages to patrons which are redeemable at participating restaurants. The patron may purchase dining packages based on the patron's dining profile which is based on the types/grades of restaurant the patron frequently dines at, the number of visits per period of time (e.g., month, year, etc.), and the number of diners per visit (i.e., size of patron's party). The patron may redeem the tickets at participating restaurants.

The patron upon arrival at the participating restaurant may present a ticket and receive special seating treatment. For example, the patron may be seated at preferred seats within the restaurant. Alternatively, the patron may receive priority treatment in the form of being the next to be seated upon arrival at the restaurant. The patron may also be guaranteed seating at participating restaurants. This is possible if the participating restaurant has reserved a certain number of seats for patrons redeeming their tickets. For example, participating restaurants may reserve about 5% to about 10% of its seating capacity for serving patrons redeeming tickets. The preferential, priority, or guaranteed seating treatment given to the patron creates a sense of goodwill and loyalty toward the restaurant because the patron knows that they will receive special seating treatment.

During the month, restaurants may serve numerous patrons and numerous patrons may visit different participating restaurants. Each time the patron visits a participating restaurant, the host may scan the ticket into a verification computer that identifies the ticket number and transmits the ticket number (i.e., patron data) to the promoter. It is also contemplated that the patron data entered into the verification computer by the host may include other information relevant to the patron's visit to the restaurant. For example, the other relevant information may relate to the patron's reason (e.g., dinner with potential customer, etc.) for visiting the restaurant. Additionally, once the patron's bill is presented to the patron, the host may enter the ticket number into the verification computer for a second transmission to the promoter. This provides the promoter with information as to the number of visits by the patron to participating restaurant and the length of the patron's stay at the participating restaurant while entertaining clients. This information may be summarized and transmitted to the patron at the end of the month such that an employer may keep track of the time its salesforce spends entertaining clients. The information collected by the promoter may also be summarized and provided to the participating restaurant.

In another aspect of the method, the restaurants may receive a percentage of the revenues generated by the sales of the dining package in exchange for its promises listed above. In particular, the group of participating restaurants may receive about sixty five percent (65%) of the revenues generated by the dining packages sold to patrons. The participating restaurants may be guaranteed this percentage even if the participating restaurant does not redeem any tickets. In this manner, the participating restaurants may receive a guaranteed source of growth and operating capital.

The tickets of the dining package may be scanned with the verification computer which may be in electronic communication with the promoter's computer. The ticket may have printed on its face a bar code. The bar code is readable by a bar code reader and contains the patron's identification number and/or ticket number. The verification computer may include a bar code reader and a modem. The bar code reader may read the bar code of the ticket, and the modem may receive the patron's identification number in electronic format and transmit the same over a telephone connection to the promoter's computer. The promoter may then collect and summarize such information and transmit the summarized information to the patron and/or the participating restaurant.

The verification computer may be leased from the promoter or a third party. The lease payments may also be automatically deducted from the percentage of dining package revenue to be distributed to the participating restaurants.

The patron may redeem the tickets by first presenting the ticket to a participating restaurant. The participating restaurant processes the patron's ticket by scanning the ticket with the verification computer which transmits the ticket information to the promoter. The promoter may update the restaurant record as well as the patron record. At the month or week end, a dining report and/or restaurant summary report may be transmitted to the patron and/or participating restaurant, respectively. Additionally, on a weekly basis (alternatively, monthly), the participating restaurant may receive a percentage of revenues generated by the sales of the dining packages.

As discussed above, participating restaurants may promise to enter its menu with prices into a website. The website provides participating restaurants a personalized web presence and not merely a name, address, telephone number listing. The website may also have a restaurant review section which explains in greater detail the type of food and experience a client may expect when dining at the participating restaurant.

The above mentioned method is beneficial to restaurants because there is no direct cost to participate in the group. Additionally, participation in the group stimulates client loyalty because clients feel that they are receiving special treatment. Additionally, the method may provide non-dilutive venture capital for operations and growth. The method also does not involve any credit card costs. Furthermore, the patron's purchase of the dining package may be non-refundable. More importantly, the increased traffic of clients to the participating restaurants may provide the participating restaurant with add on sales such as liquor, evening dining, and/or evening dining with a 10% discount.

The above mentioned method is also beneficial to patrons, especially, businesses that pay for dinners with customers because the method discussed herein controls dining costs and entertainment costs. It improves cost control. The tickets may be redeemed by anyone of the business's salesforce and at a variety of participating restaurants. The cost of the dining package is tax deductible. Also, the method may reduce administrative expenses due to accounting and expense auditing.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a diagram of various steps for a method of developing and retaining clients for restaurants;

FIG. 2 is a diagram of a promoter forming agreements with a plurality of restaurants and selling dining packages to a plurality of patrons;

FIG. 3 is an exemplary dining ticket of the dining package;

FIG. 4 is a diagram of various promises made between the promoter and restaurants in the forming agreement step;

FIG. 5 is a front cover of the dining package;

FIG. 6 is a back cover of the dining package;

FIG. 7 is a diagram of the restaurant processing the ticket via a verification computer and the promoter transmitting a dining report and/or restaurant summary report to the patron and/or the restaurant, respectively;

FIG. 8 is an exemplary restaurant summary report transmitted to the restaurant; and

FIG. 9 is a flowchart of the process of redeeming the tickets and transmitting the dining report and/or the restaurant summary report to the patron and/or the restaurant.

### DETAILED DESCRIPTION

As used herein, “patron” may refer to a business or its salespeople. Additionally, “patron” may refer to an individual.

A method of developing and retaining clients for restaurants is provided. The method is directed to providing patrons special seating treatment and/or discounted pricing on dining packages. Also, the method may also include providing print and/or web based advertisements for participating restaurants to attract clients and patrons to participating restaurants. The method may also relate to providing participating restaurants with a source of growth capital and operating capital such that the restaurant is better able to respond to increased cash flow requirements associated with increased business.

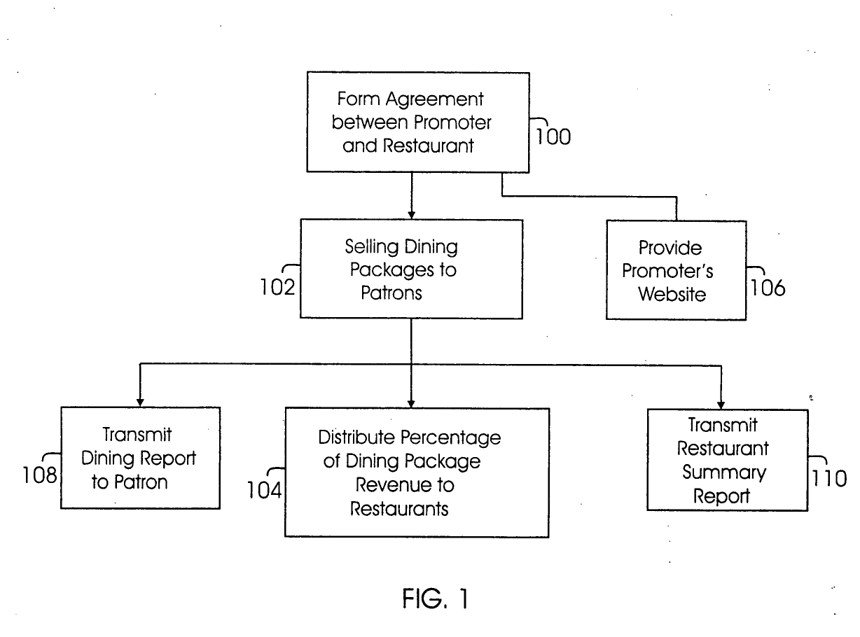

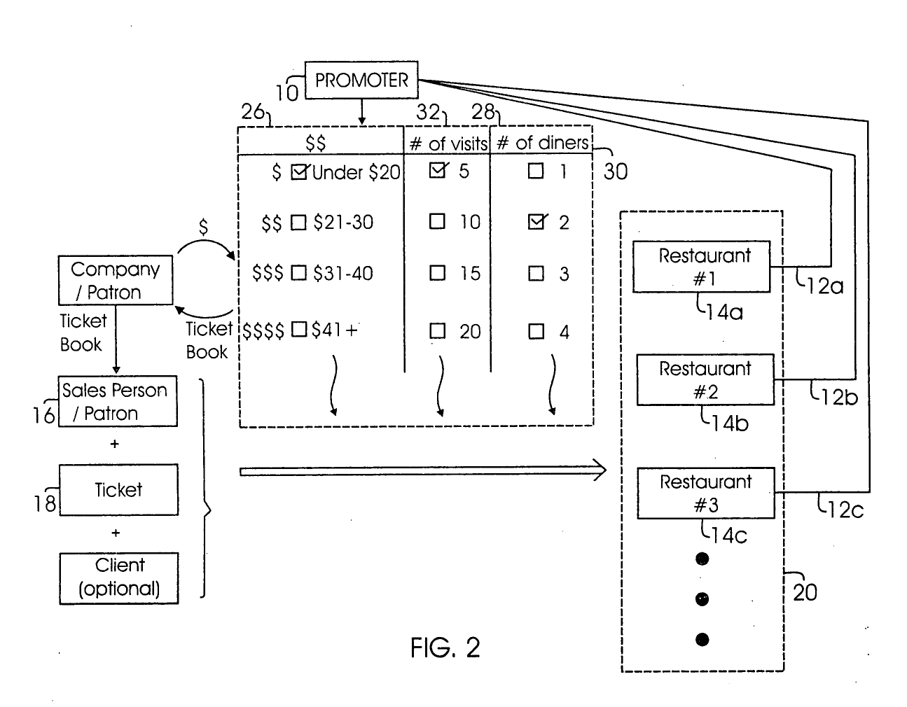

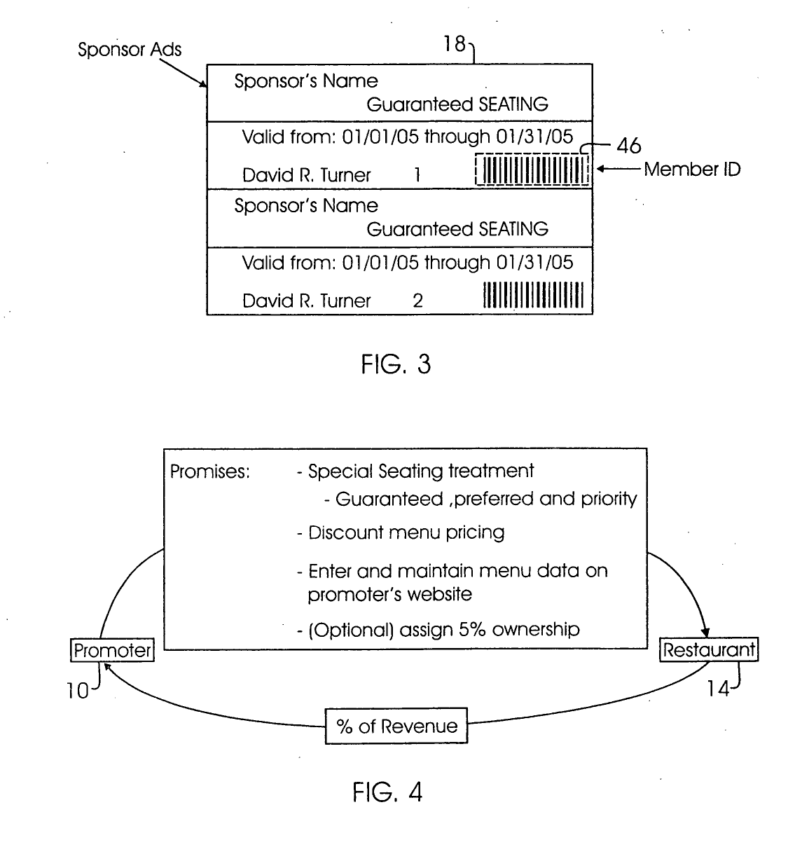

A first step in the method may include the step of forming 100 (see FIG. 1) an agreement with a plurality of restaurants within a region. As shown in FIG. 2, the promoter 10 may enter into agreements shown by lines 12a, b, c with the plurality of restaurants 14a, b, c. These restaurants 14a, b, c may agree to provide special pricing discounts and/or special seating treatment to patrons 16 upon presentation of a meal ticket 18 (see FIGS. 2 and 3) to one of the participating restaurants 14a, b, c. More particularly, in the first step of forming 100 an agreement, the promoter 10 and restaurant 14 may execute a promoter's agreement which specifies the rights and obligations of the promoter 10 and the restaurant 14, as shown in FIG. 4. The promoter's agreement may specify that the restaurant 14 must provide special seating treatment to patrons 16 redeeming tickets. The promoter's agreement may also specify that the restaurant 16 agrees to provide meals to such patrons 16 at a discounted price.

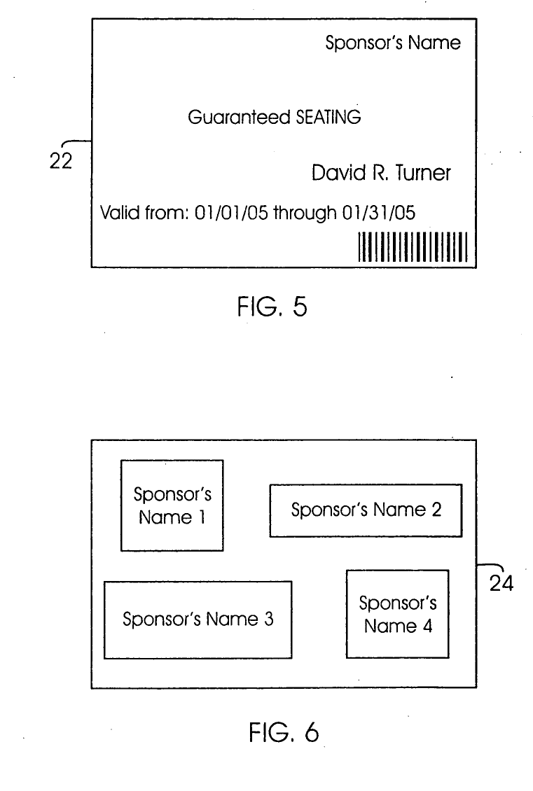

As shown in FIG. 1, a second step in the method may include the step of selling 102 dining packages (see FIGS. 3, 5 and 6) to patrons 16 in the region. The dining package may comprise a plurality of the meal tickets 18 (see FIG. 3) with a front cover 22 (see FIG. 5) and a back cover 24 (see FIG. 6). Each ticket 18 may be redeemed at participating restaurants 14 within a restaurant grade 26, each ticket 18 may also be redeemed for a specific quantity of meals 28, and each meal may include a set meal course (e.g., soup or salad, main entrée, desert and drink).

The dining package may comprise a plurality of tickets 18 (see FIG. 3). Each ticket 18 may entitle the patron 16 with one or more meals per visit at a restaurant 14. For example, the ticket 18 may entitle the patron 16 to two meals per visit at a restaurant with an average entrée cost of twenty one (21) to thirty (30) dollars. Also, each meal may include a salad, main entrée, desert and a drink. It is also contemplated that different meal courses may be sold to patrons. By way of example and not limitation, the meal course may include only a main entrée and drink, or each ticket may include one or more appetizers with each meal course including a main entrée, desert and drink.

As stated above, the promoter 10 may offer and sell a plurality of the dining packages to patrons 16. By way of example and not limitation, patrons 16 may be businesses, salespersons, or individuals. Businesses may purchase dining packages and distribute tickets 18/dining packages to its employees (e.g., salespersons, etc.) for client development and entertainment purposes. These dining packages may be beneficial to businesses that discuss business with clients and vendors over a meal (e.g., breakfast, lunch or dinner) because it helps businesses control entertainment costs by its employees, as will be discussed further below. Also, individuals may purchase dining packages to reduce the cost of eating at restaurants 14. For example, young married couples with respective careers may purchase these dining packages to minimize the cost of eating at restaurants 14.

The promoter 10 may sell dining packages to patrons 16 based on the patron's dining profile 30, as shown in FIG. 2. The dining profile 30 may reflect the patrons preference with respect to restaurant grade 26 (e.g., under $20, $21-$30, $31-$40, $41 and above, etc.), the average number of visits 32 (e.g., 5, 10, 15, 20, etc.) per time period (e.g., weekly, monthly, yearly, etc.) and the average size of the patron's party 28 (e.g., 1, 2, 3, 4, etc.) per visit. If the patron 16 frequents restaurants 14 in the under $20 range approximately five (5) times a month with an average party size of two, then the promoter 10 may sell a dining package to the patron 16 to fit the patron's profile.

The special seating treatment may include preferred seating, priority seating or guaranteed seating. Preferred seating may include providing seats within the restaurant 14 which are more desireable than other seats within the restaurant 14. For example, restaurants 14 on hill tops with a view of the city lights may provide patrons 16 redeeming tickets 18 with seats having a view of the city lights. Priority seating may include providing seats to patrons 16 on a last-come first-serve basis. For example, if the restaurant 14 has a waiting list of clients to be seated and it would normally take forty five (45) minutes to be seated, then the patron 16 who has just arrived at the restaurant 14 may be given the next available seating upon presentation of a ticket 18 to shorten the current forty five (45) minute wait. Guaranteed seating may include seating patrons 16 even though all seats have been reserved. For example, high-demand restaurants 14 may be booked to capacity. However, with guaranteed seating, patrons 16 redeeming tickets 18 may be seated and served even though the restaurant 14 is booked to capacity. This may be accomplished by leaving about 1% to about 50% of the restaurant's seating capacity to patrons 16 redeeming tickets 18. Preferably, the restaurant maintains about 5% to about 10% of the restaurant's seating capacity for patrons 16 redeeming tickets 18.

Special seating treatment discussed above may include treating patrons 16 redeeming tickets 18 ahead of other clients within the restaurant's normal ordered seating procedure. For example, in priority seating, the normal ordered seating procedure for restaurants may be first-come first-served. The first client to register with the host/hostess will generally be the first party to be seated. However, special seating treatment includes treating clients redeeming tickets out of the normal ordered seating procedure such that the patron is ahead of other clients waiting to be served. The restaurant may have a list of clients waiting to be seated. The patron redeeming a ticket may proceed to the top of the list such that the patron will be the next party to be seated. Hence, the patron is seated out of the normal ordered seating procedure of the restaurant.

As stated above, the dining packages may be offered to patrons 16 at discounted pricing. For example, if a salad, main entrée, desert and drink would cost on average about fifty (50) dollars for each meal at a particular restaurant grade, then the dining package may be priced at about thirty five (35) dollars per meal. Hence, if the patron 16 purchased fifteen tickets for a party of four people, then the dining package for the above mentioned meal would be priced at thirty five dollars multiplied four people multiplied by fifteen visits for a sum total of two thousand one hundred dollars for meals valued at three thousand dollars (i.e., fifty dollars multiplied by four people multiplied by fifteen visits). The above example using a thirty percent discount rate was given merely for example and not to limit the present invention to such discount rate. Accordingly, the discount pricing of the dining package price may vary based on restaurant grade, number of tickets, and number of meals (i.e., size of party) per ticket as well as other factors. Generally, the discount rate may increase as the restaurant grade, number of tickets and the numbers of meals per ticket increase. The discount rate may be about 5% to about 75%. Preferably, the discount rate is about 35%.

In a third step of the method, as shown in FIG. 1, the promoter may distribute 104 a percentage of the revenues generated via sales of dining packages within each restaurant grade 26 to the group of restaurants 14 within the respective restaurant grade 26. The funds may be distributed to the restaurants 14 even if the restaurant 14 does not redeem any tickets 18. Accordingly, the distributed revenues provide the restaurants 14 with a consistent source of growth capital and operating capital such that the restaurants 14 may upgrade the restaurant as the restaurant grows. For example, if twenty five hundred (2,500) patrons 16 purchased varying dining packages for restaurants 14 within the $21 to $30 restaurant grade with revenues of about $6,400,000 then $4,160,000 may be divided by the number of participating restaurants 14 within the $21 to $30 restaurant grade and distributed to restaurants 14 within such restaurant grade 26. Also, a lease payment for a verification computer 44 (discussed below) may be deducted automatically from the percentage of revenues to be distributed.

In a fourth step of the method, as shown in FIG. 1, the promoter may provide a promoter's website 106 with restaurant content and/or other types of content to draw internet users to the promoter's website. The promoter's website may have a link and webpages dedicated to various restaurants wherein internet users may search for participating restaurants and view various details regarding participating restaurants. For example, the promoter's website may have a listing of various restaurants within a region such as Orange County, Calif. The listing may include participating restaurants 14 and (optionally) non-participating restaurants. The website may further provide details relating to participating restaurants 14 such as menu with prices and other unique features of the restaurant 14. Optionally, the website may also include various pictures of the restaurant 14 to illustrate the type of ambiance the participating restaurant 14 provides to its clientele.

Additionally, the promoter's website may include a system for patrons 16 to reserve seating at any of the plurality of participating restaurants 14 online. By way of example and not limitation, the promoter's website may permit patrons 16 to purchase dining packages online and print the dining package tickets 18. Additionally, the patron 16 may reserve seats at any participating restaurant for any day of the week. The promoter 10 may confirm the patron's reservation immediately because the restaurant 14 has already promised via the promoter's agreement that patrons redeeming tickets 185 would be provided with special seating treatment. For example, the patron may have purchased tickets 18 with guaranteed seating. In this regard, participating restaurants 14 agreeing to provide guaranteed seating may reserve about 5% to about 10% of their seating capacity for patrons 16 redeeming tickets 18. Accordingly, the promoter 10 does not need to confirm the patron's reservation made via the promoter's website with the restaurant 14. Hence, the patron's total time to reserve seats at the participating restaurant 14 online is reduced because the promoter 10 does not have to confirm the patron's reservation with the participating restaurant 14. As a courtesy to the participating restaurant 14, the promoter 10 may notify the participating restaurant 14 of the patron's reservation.

The promoter 10 may also provide an administrative website for the participating restaurants 14 which permits the participating restaurant 14 to remotely enter in the restaurant's menu and respective prices, pictures of the participating restaurant 14, textual information relating to the participating restaurant 14, and the like to update the participating restaurant's information on the promoter's website.

The promoter 10 may provide participating restaurants 14 with a plurality of print advertisements to assist the restaurant 14 in attracting clientele, and to inform clients that they are associated with the promoter and offer dining packages for sale. By way of example and not limitation, participating restaurants 14 may be provided with point of sale displays advertising dining packages, monthly postage paid ticket envelopes for returning redeemed tickets 18 to the promoter 10, table “RESERVE” signs, and plaque, stickers and logos for menus indicating that the restaurant 14 has joined the promoter's group of participating restaurants 14.

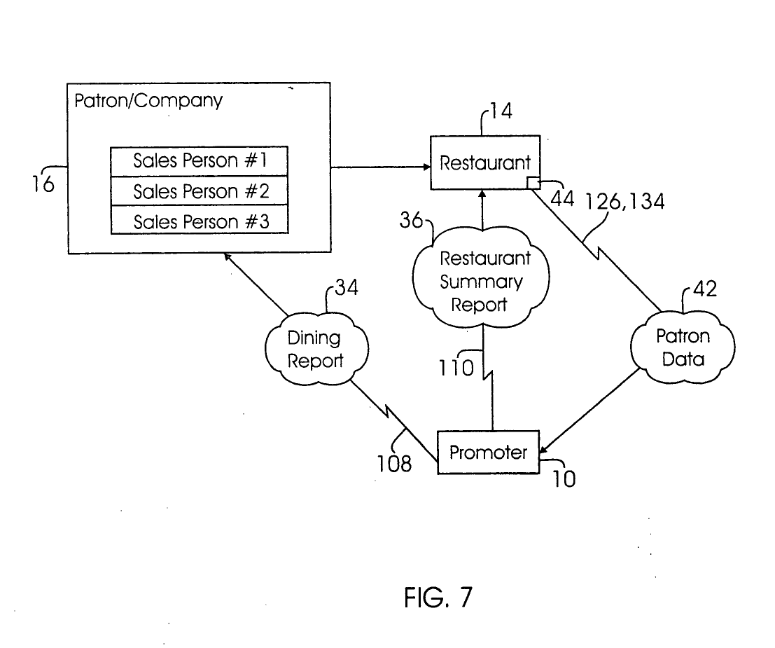

In a fifth step of the method, the promoter may transmit 108 a dining report 34 to the patron 16, as shown in FIGS. 1 and 7. The dining report 34 may include the day and time that the patron 16 redeemed tickets 18 at participating restaurants 14, the patron's name, a stated reason for the visit (e.g., dinner with client, etc.) and other useful information to the patron 16. The day and time information may include the date of visit and the arrival and departure times of the patron 16. This information may be useful to businesses/employers that distribute tickets 18/dining packages to its employees to entertain clients by permitting employers to keep track of the time its employees spend on entertaining clients. It also provides employers with a means to audit the employee's time.

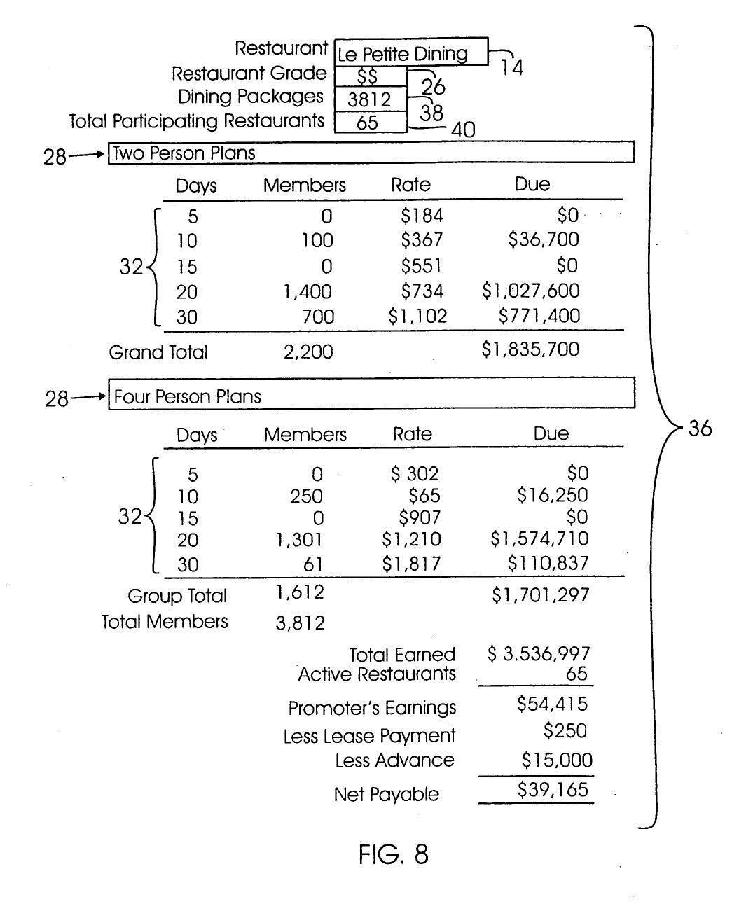

In a sixth step of the method, the promoter may transmit 110 a restaurant summary report 36 to the participating restaurant 14, as shown in FIGS. 1, 7 and 8. An example of the restaurant summary report 36 is shown in FIG. 8. The restaurant summary report 36 may identify the restaurant 14, its restaurant grade 26, the total number of patrons/dining packages sold 38 and the total number of participating restaurants 40 within the restaurant grade 26. With this information, the distribution of the revenue percentage due to sales of dining packages may be calculated and disclosed to the participating restaurants such that restaurants may be assured that the proper amount of funds are being distributed to them 14. The restaurant summary report 36 may further break down the dining packages sold according to the patron's party size 28 and the number of visits per time period 32. It is also contemplated that patron information may also be provided in the restaurant summary report 36. By way of example and not limitation, the number of patrons actually served, the party size of the served patron, the patron's length of stay at the restaurant, and/or other information relevant to the effectiveness and efficiency of the method disclosed herein and the restaurant 14 may be included in the restaurant summary report 36.

The dining report 34 and the restaurant summary report 36 may be provided to the patron 16 and the restaurant 14, respectively, via data 42 gathered by the restaurant 14, as shown in FIG. 7. The data 42 may be gathered by the restaurant 14 via a verification computer 44 located at the restaurant 14. The verification computer 44 may include a bar code reader and a modem. The bar code reader may be an optical reader operative to read information encoded in the ticket 18 in the form of a bar code 46 (see FIG. 3). By way of example and not limitation, the ticket's bar code 46 may include information relating to the patron's identification number, and/or other relevant information. An exemplary ticket 18 is shown in FIG. 3 with accompanying front cover 22 (see FIG. 5) and back cover 24 (see FIG. 6) of the dining package.

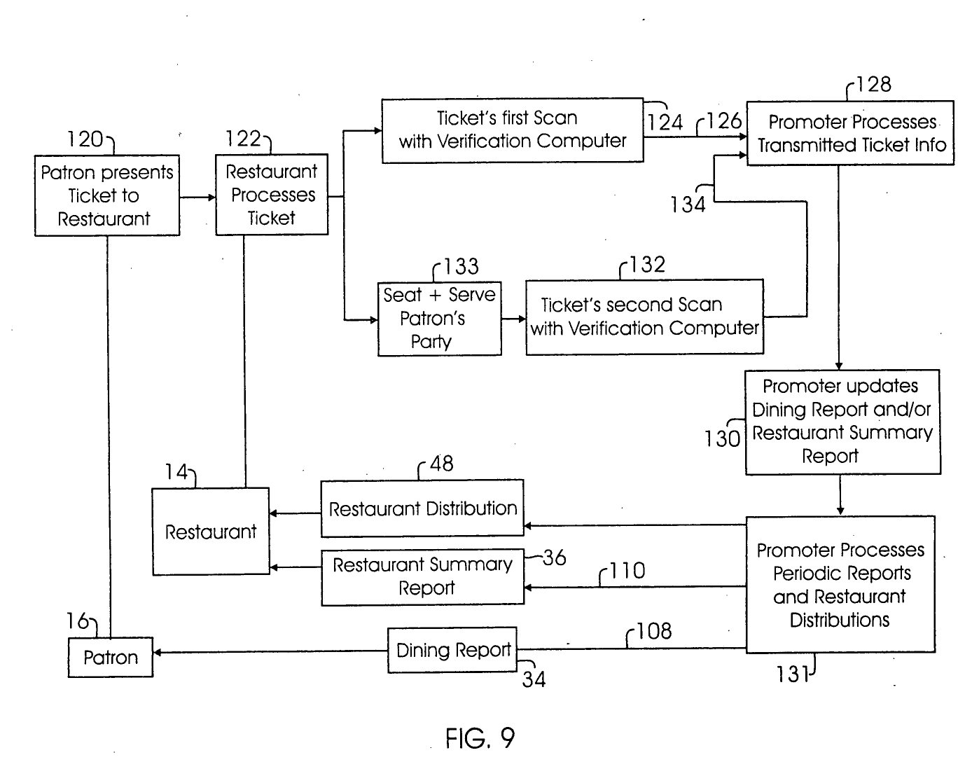

Referring now to FIG. 9, the patron 16 may go and present (step 120) a ticket 18 to the restaurant 14. The restaurant 14 may process (step 122) the ticket 18 by scanning (step 124) the ticket's bar code 46 via the verification computer's bar code reader. The patron data 42 may be stored on the verification computer 44 and transmitted (step 126) to the promoter 10 via the modem. By way of example and not limitation, the patron data 42 may be emailed or otherwise transmitted to the promoter 10. The promoter 10 may process (step 128) the received patron data 42 updating (step 130) the dining report 34 and/or restaurant summary report 36 to be provided to the patron 16 and/or the restaurant 14, respectively. Also, the promoter 10 may transmit (step 108) the dining report 34 to the patron 16 periodically, and the promoter 10 may transmit (step 110) the restaurant summary report 36 to the restaurant 14 along with the restaurant's distribution 48 associated with the percentage of dining package revenues, periodically.

Additionally, the patron 16 may receive (step 133) special seating treatment in the form of preferred seating, priority seating or guaranteed seating once the patron 16 presents (step 120) the ticket 18 to the restaurant 14. After the patron's party is finished with the meal, then the restaurant may present any charges above the pre paid meal such as liquor. Also, at this time, the restaurant 14 may scan (step 132) the patron's ticket 18 again thereby transmitting (step 134) the approximate departure time of the patron 16 to the promoter. The promoter 10 may update (step 130) the dining report 34 and/or the restaurant summary report 36.

The above mentioned method has many unique advantages. In particular, patrons 16 are treated with special seating privileges which promotes loyalty to the restaurants 14. The reason is that the patron 16 is treated as a preferred client of the restaurant 14 and the patron's guests (e.g., potential business clients of patron, etc.) is treated as preferred clients. Additionally, patrons 16 may be provided with discount pricing on the menu by pre ordering a bulk set of meals. Furthermore, the restaurants 14 are provided with capital to assist in the growth of the restaurant 14 and its operations.

The above description is given by way of example, and not limitation. Given the above disclosure, one skilled in the art could devise variations that are within the scope and spirit of the invention disclosed herein, including various ways of transmitting the ticket information (e.g., patron data, etc.) to the promoter. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A method of developing and retaining patrons for a restaurant, the restaurant having an ordered seating procedure, the method comprising the steps of:
a) entering into agreements with a plurality of restaurants wherein the restaurants promise to seat patrons redeeming tickets ahead of the restaurant's ordered seating procedure; and
b) providing dining packages to a plurality of restaurant patrons, each dining package having a plurality of tickets, each ticket being redeemable at the restaurant for a meal course at the restaurant.

2. The method of claim 1 wherein the providing dining packages step includes the step of selling the dining packages to a plurality of restaurant patrons.

3. The method of claim 2 further comprising the step of forwarding a percentage of dining package revenue to the restaurants.

4. The method of claim 3 wherein the percentage is between about 5% to about 90% of the aggregate of dining package revenues.

5. The method of claim 3 wherein the percentage is about 65% of the aggregate of dining package revenues.

6. The method of claim 1 further comprising the step of receiving patron data from the restaurant, and preparing and transmitting a restaurant summary report based on the received patron data to the restaurant.

7. The method of claim 6 further comprising the step of receiving patron data from the restaurant, and preparing and transmitting a dining report based on the received patron data to the patron.

8. The method of claim 5 wherein the patron data is an arrival time and departure time of the patron at the restaurant.

9. The method of claim 1 wherein the dining package is customizable according to the grade type of the restaurant, the party size of the patron and the number of visits per time period.

10. The method of claim 9 wherein the grade type of restaurant comprises restaurants with an average entrée cost of under twenty dollars, between twenty one dollars and thirty dollars, between thirty one dollars and forty dollars, and more than forty dollars.

11. The method of claim 9 wherein the party size of the patron may be one, two, three, and four.

12. The method of claim 9 wherein the number of visits per time period may be five visits per month, ten visits per month, fifteen visits per month, and twenty visits per month.

13. The method of claim 1 wherein in the entering into agreements step, the restaurant promises to provide a meal course to the patron redeeming the ticket at a discounted price compared to the normal price.

14. The method of claim 13 wherein a discount rate used to calculate the discounted price increases as a restaurant grade, number of tickets, and number of meals per ticket increases.

15. The method of claim 1 wherein the meal includes a soup or salad, main entrée, desert and a drink.

16. The method of claim 1 wherein the ordered seating procedure is a by reservation only procedure.

17. The method of claim 1 wherein the ordered seating procedure is a first-come, first-serve procedure.
